(19) United States
(12) Patent Application Publication
(10) Pub. No.: US 2012/0113678 A1
(43) Pub. Date: May 10, 2012

(54) LIGHT GUIDE APPARATUS

(75) Inventors: Hugo Johan Cornelissen, Eindhoven (NL); Dirk Kornelis Gerhardus Boer, Den Bosch (NL); Gongming Wei, Shanghai (CN)

(73) Assignee: KONINKLIJKE PHILIPS ELECTRONICS N.V., EINDHOVEN (NL)

(21) Appl. No.: 13/263,892

(22) PCT Filed: Apr. 16, 2010
(86) PCT No.: PCT/IB2010/051658

§ 371 Date: Jan. 10, 2012

(30) Foreign Application Priority Data
Apr. 16, 2009 (CN) 200910132759.4

(51) Int. Cl. F21V 8/00; G02B 6/34

(52) U.S. Cl. 362/607; 362/606; 362/608

(57) ABSTRACT

The present invention aims to provide a light guide apparatus based on diffraction gratings. The apparatus comprises a light guide plate (11) comprising a first diffraction grating (13) located on a first surface of or inside the light guide plate (11); a first light source (12), coupled to a first side of the light guide plate (11); wherein the first diffraction grating (11) is configured to extract the light generated by the first light source (12) from the first surface of the light guide plate (11). Since the first diffraction grating (13) is invisibly small, users hardly notice any change of the light guide (11). When the light guide apparatus of the present invention is used as a book reader, the dark area produced when lifting the book reader in a direction away from the objects to be read is smaller than that of existing light guide apparatus based on microstructures, since the light exit angle is relatively small when using a diffraction grating.

### FIELD OF THE INVENTION

The present invention relates to light guide apparatus, particularly to light guide apparatus used for book readers.

### BACKGROUND OF THE INVENTION

A previous Philips patent application publication, international publication number: WO2008/087593, entitled “ILLUMINATION DEVICE”, filed on Jan. 16, 2008, proposed a book reader based on a light guide 35 having optical microstructures 51 that cause the guided light 21 to exit 21′ at a large angle with the surface normal, as shown in FIG. 1. From a plot of the angular distribution of the emitted light it can be seen that the exit angle is approximately 80° with respect to the normal to the bottom surface of the light guide 35, as illustrated in FIG. 2. In the second drawing of FIG. 2, the horizontal axis denotes the inclination angle, and the vertical axis denotes illumination intensity.

However, the micro-structures in FIG. 1 have a certain size, for instance the spacing is 0.1 mm, which under certain circumstances results in visible artefacts. There is a need for smaller, invisible light outcoupling structures. The light exits the light guide at a large angle with the surface normal, e.g. 80°, as shown in FIG. 2. As a consequence, when the book reader is lifted a few mm from the book page, a dark band quickly appears. There is a need to reduce this effect by making the light exit the light guide at a smaller angle with the surface normal. Finally, the light guide is very sensitive to fingerprints, dust particles and scratches, because the light propagates in the light guide at angles very close to, and exceeding the critical angle for Total Internal Reflection (TIR). There is a need for a robust, scratch-resistant configuration.

### SUMMARY OF THE INVENTION

The present invention aims to provide a light guide apparatus based on diffraction gratings to improve on the performance of the prior art.

According to an embodiment of the present invention, there is provided a light guide apparatus comprising: a light guide plate comprising a first diffraction grating located on a first surface of or inside the light guide plate; a first light source, coupled to a first side of the light guide plate; wherein the first diffraction grating is configured to extract the light generated by the first light source from the first surface and a second surface, opposite the first surface, of the light guide plate.

The light guide apparatus of the present invention uses a diffraction grating as the light extraction structure. Since the diffraction grating is invisibly small, the users hardly notice any change of the light guide.

When the light guide apparatus of the present invention is used as a book reader, the dark area produced when lifting the book reader in a direction away from the objects to be read is smaller than for an existing light guide based on microstructures, since the light exit angle is relatively small when use is made of a diffraction grating.

According to an embodiment of the present invention, the pitch of said first diffraction grating is smaller than the shortest main wavelength of said light. In such a situation, only the first order diffraction occurs, no ambient light will be diffracted and there is also no second order diffraction to be suppressed.

According to an embodiment of the present invention, the pitch of said first diffraction grating is larger than the longest main wavelength of said light. In such a situation, not only the first order diffraction but also the second order diffraction occurs. The diffraction grating is square shaped to suppress the second order diffraction. In such a situation, a larger clear viewing cone is achieved. The clear viewing cone is the area where no light is emitted, which will be illustrated in the following Figures.

According to an embodiment of the present invention, the light guide plate has two cladding layers covering respectively said first and second surface of the light guide plate and the index of either of the cladding layers is lower than the index of said light guide plate. By using the cladding layers, the light guide plate is scratch-resistant. Alternatively, in the case of a cladding configuration, the light guide apparatus further comprises a tapered collimator between the light source and the light guide plate for preventing the light from entering the cladding layers directly.

Alternatively, the light guide apparatus further has a diffuser between said first light source and said light guide plate. Alternatively, the light guide apparatus further has a mixing light guide between the first light source and the diffuser.

Alternatively, the light guide apparatus further comprises a second light source, coupled to a second side, opposite to the first side, of the light guide plate to achieve a much stronger diffraction light intensity.

According to another embodiment of the present invention, the light guide apparatus further comprises a second diffraction grating, crossed or parallel to said first diffraction grating, and located on a second surface, opposite the first surface, of or inside said light guide plate.

By using two diffraction gratings, the light guide apparatus extracts a much stronger light intensity. By using two diffraction gratings with different pitches, the light guide apparatus achieves a larger clear viewing cone.

According to another embodiment of the present invention, there is provided a light guide device comprising two light guide apparatus as described above: a first light guide apparatus and a second light guide apparatus, wherein the first diffraction grating of the first apparatus has a smaller pitch than the first diffraction grating of the second apparatus, the light injected into the first diffraction grating of the first apparatus has a shorter wavelength than the light injected into the first diffraction grating of the second apparatus, and the light guide plate of the first apparatus is not in contact with the light guide plate of the second apparatus.

### DESCRIPTION OF THE DRAWINGS

The above and other objects and features of the present invention will become more apparent from the following detailed description considered in connection with the accompanying drawings, in which:

FIG. 1 is a schematic view of a light guide 35 having optical microstructures 51;

FIG. 2 is a plot of the angular distribution of the emitted light from the light guide 35 in FIG. 1;

FIG. 3 (a) is a schematic view of a light guide apparatus according to an embodiment of the present invention;

FIG. 3 (b) is a schematic view of another light guide apparatus according to an embodiment of the present invention;

FIG. 4 is a schematic view of a light guide apparatus with two light sources according to an embodiment of the present invention;

FIG. 5 is a schematic view of the optical path of a diffraction grating;

FIG. 6 is a schematic view of the optical path of a light guide apparatus, based on a diffraction grating having a pitch smaller than the shortest main wavelength of the light emitted by the first light source 12 according to an embodiment of the present invention;

FIG. 7 is a schematic view of the angular distribution of the diffraction light in FIG. 6;

FIG. 8 is a schematic view of the optical path of a light guide apparatus having two light sources 12 according to another embodiment of the present invention;

FIG. 9 is a schematic view of the angular distribution of the diffraction light in FIG. 8;

FIG. 10 is a schematic view of the optical path of a light guide apparatus used as a book reader;

FIG. 11 is a schematic view of the optical path of a light guide apparatus, based on a diffraction grating 13 having a pitch larger than the longest main wavelength of the light emitted by the first light source 12 according to an embodiment of the present invention;

FIG. 12 is a schematic view of the angular distribution of the first and second order diffraction light in FIG. 11;

FIGS. 13 (a) and (b) respectively show the diffraction efficiencies of sinusoidal and square gratings with a large pitch of 700 nm;

FIG. 14 is a schematic view of the optical path of a light guide apparatus, based on a square shaped grating 13 with illumination from two sides;

FIG. 15 is a schematic view of a light guide apparatus coated with two low-index polymer cladding layers 17 and 17′;

FIG. 16 is a schematic view of a light guide apparatus coated with two low-index polymer cladding layers having a tapered collimator 18 between the light source 12 and the light guide plate 11 for preventing the light from entering the cladding layers;

FIGS. 17 (a), (b) and (c) show the diffraction efficiency of a square grating 13 with a large pitch of 700 nm;

FIG. 18 is a schematic view of a light guide apparatus having a diffuser 19 between the first light source 12 and the light guide plate 11;

FIG. 19 is a schematic view of a light guide apparatus having a mixing light guide 110 and a diffuser 19 between the first light source 12 and the light guide plate 11;

FIG. 20 is a schematic view of a light guide apparatus having a tapered collimator 18 and a diffuser 19;

FIG. 21 is a schematic view of a light guide apparatus with two parallel diffraction gratings 13 and 111;

FIG. 22 is a schematic view of two crossed diffraction gratings 13 and 111, respectively, located on the two surfaces 104 and 105 of a light guide plate;

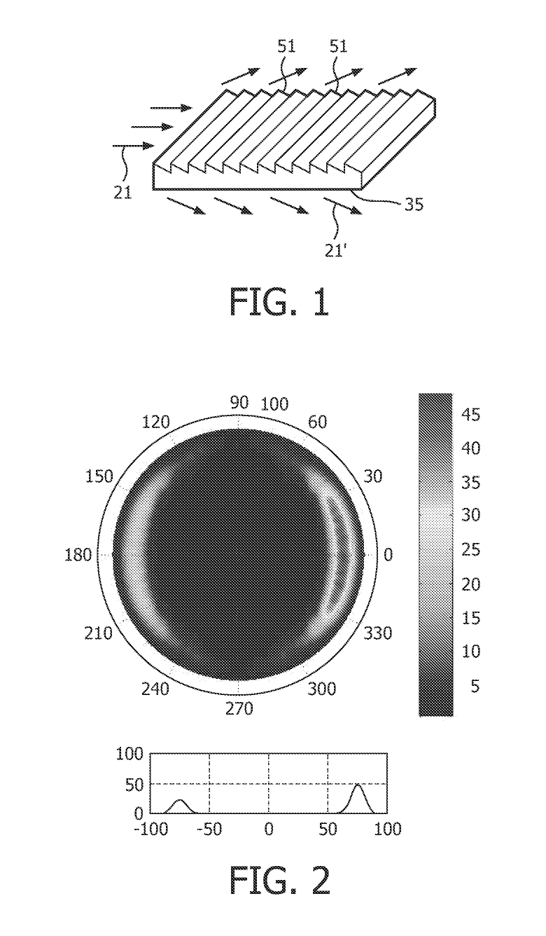

The same reference numerals are used to denote similar parts throughout the Figures.

### DETAILED DESCRIPTION

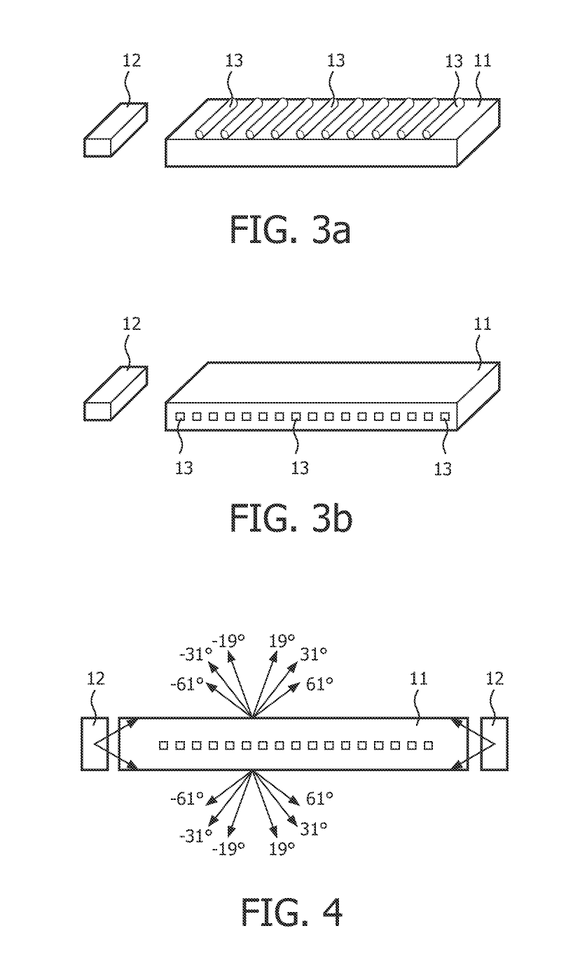

Referring to FIG. 3, FIG. 3 shows a light guide apparatus according to an embodiment of the present invention. The light guide apparatus in FIG. 3 includes a light guide plate 11 and a first light source 12. The light guide plate 11 has a first diffraction grating 13 on its first surface. The first light source 12 is coupled to a first side of the light guide plate 11. The first light source 12 includes a single LED, OLED, CCFL or EL or a plurality thereof. The light guide plate 11 can be made of polycarbonate (PC) or polymethylmethacrylate or PolyStyrene (PS) or Cyclic Olefin Copolymer (COC) etc.

In a variant embodiment of FIG. 3, the first diffraction grating 13 can also be located inside the light guide plate 11, as shown in FIG. 4.

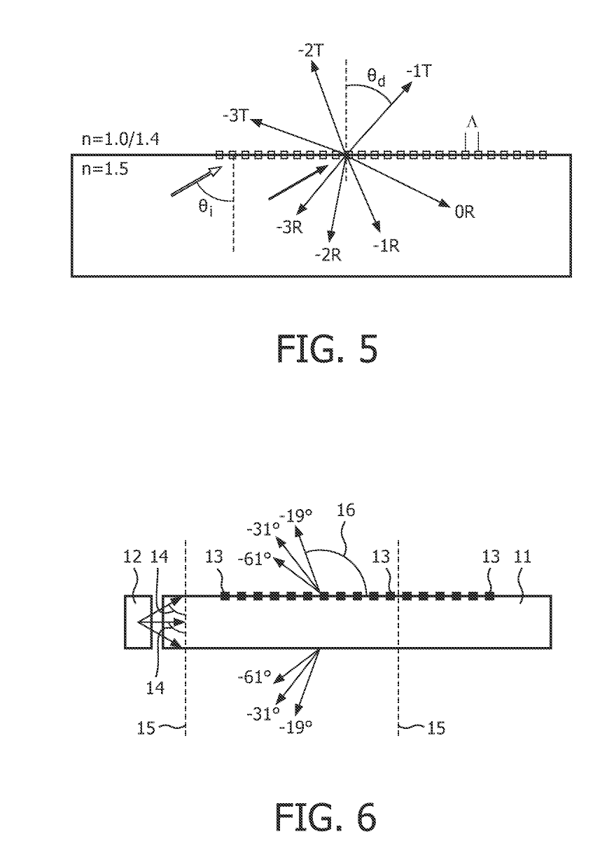

Alternatively, the light guide apparatus further comprises a second light source 12, coupled to a second side, opposite to the first side, of the light guide plate 11, as shown in FIG. 5.

In FIG. 5, light is injected into the light guide plate 11 from two sides. The first diffraction grating 13 extracts light from the top and bottom surface, i.e. the first surface and the second surface of the light guide plate 11.

Consider light travelling in a light guide with index of refraction nᵢ. The light strikes a diffraction grating at the surface at an inclination angle θᵢ and azimuthal angle φᵢ. The directions of the diffracted beam θ_{d} and φ_{d} can be solved using the following equation:

n_{d} sin(θ_{d})cos(φ_{d})=nᵢ sin(θᵢ)cos(φᵢ)+mλ/Λ

n_{d} sin(θ_{d})sin(φ_{d})=nᵢ sin(θᵢ)sin(φᵢ) (1)

where m is the diffraction order (. . . −2, −1, 0, +1, +2, . . . ), λ the wavelength of the light, Λ is the pitch of the grating, and n_{d} is the refractive index of the medium outside the light guide. Without loss of generality, let azimuthal angle φᵢ=φ_{d}=0; then equation (1) becomes equation (2):

n_{d} sin(θ_{d})=nᵢ sin(θᵢ)+mλ/Λ (2)

From equation (2), it can be seen that the value of the pitch of the first diffraction grating 13 is dependent on many parameters, such as the wavelength of the light emitted by the first or second light source 12 and the incidence angle of the light.

Without loss of generality, in the following embodiments, the azimuthal angle of the incidence light and the diffraction light is supposed to be zero for simplicity.

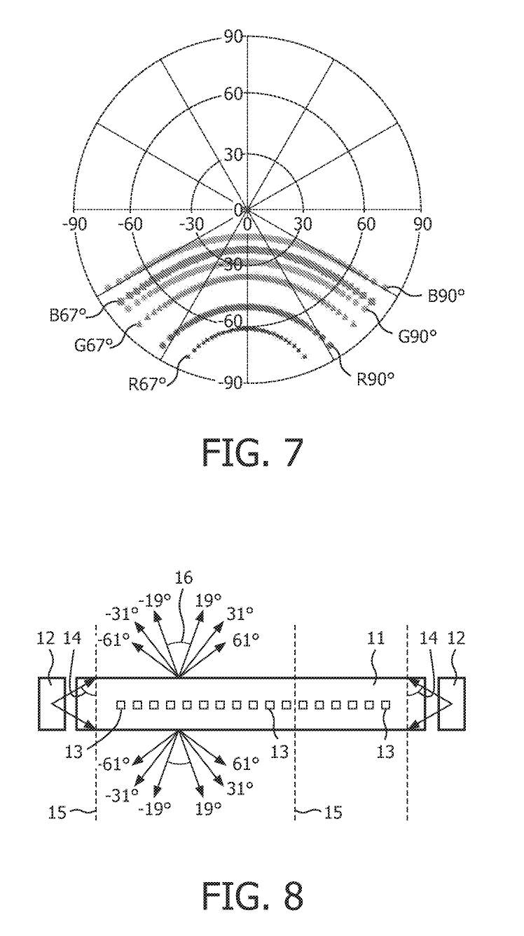

In an embodiment, the pitch of the first diffraction grating 13 is smaller than the shortest main wavelength of the light emitted by the first light source 12. For example, the first light source 12 includes three LEDs, the first one emitting red light having a wavelength of 620 nm, the second one emitting green light having a wavelength of 530 nm, and the third one emitting blue light having a wavelength of 470 nm. The pitch of the first diffraction grating 13 is 275 nm. FIG. 6 shows a schematic view of the optical path of such a light guide apparatus with illumination from one side and the index n of light guide plate 11 being 1.50. In FIG. 6, the incidence angle θᵢ 14 of the light is 90° and 67° with the surface normal 15 to the first surface of the light guide plate 11 and only the first order diffraction occurs. The red light exits the light guide plate 11 at an angle of −61°. The green light exits the light guide plate 11 at an angle of −31°. The blue light exits the light guide plate 11 at an angle of −19°. In FIG. 6, a large asymmetric clear viewing cone 16 is achieved: −19° to +90°. When the light guide apparatus is used as a book reader, the person reading should observe the page under the light guide plate 11 close to the surface normal 15, with his eyes in the clear viewing cone 16. FIG. 7 shows the angular distribution of the diffraction light, in which “R”,“G” and “B” respectively denote the red light rays, the green light rays and the blue light rays.

FIG. 8 shows the optical path of another light guide apparatus according to another embodiment of the present invention. In FIG. 8, the light guide apparatus has two light sources, the first light source 12 and the second light source 12, located at two opposite sides of the light guide plate 11. Similar to the apparatus of FIG. 6, each light source 12 in FIG. 8 has three LEDs, the first one emitting red light having a wavelength of 620 nm, the second one emitting green light having a wavelength of 530 nm, the third one emitting blue light having a wavelength of 470 nm. The pitch of the first diffraction grating 13 is 275 nm.

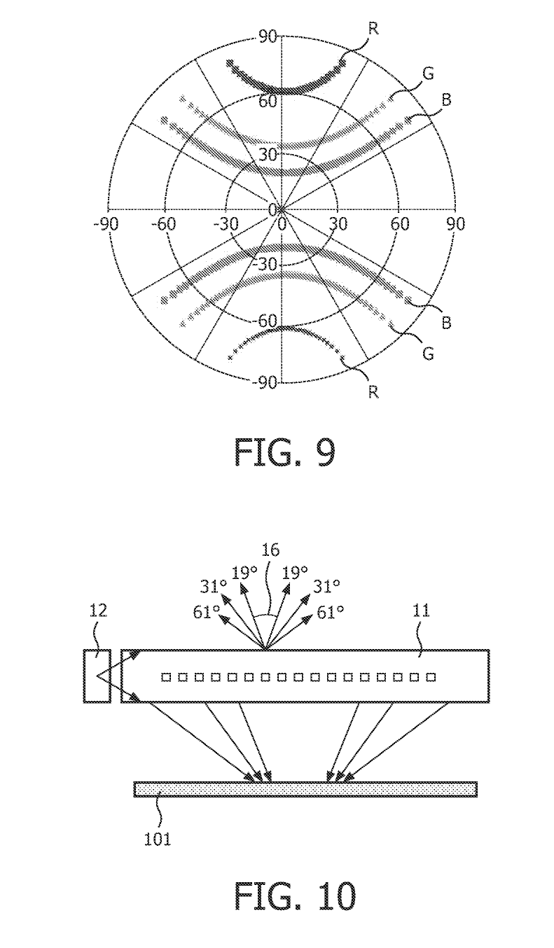

The refractive index of the light guide plate 11 is 1.5. In FIG. 8, the incidence angle θᵢ 14 of the light is 67° with the surface normal 15 to the first surface of the light guide plate 11 and only the first order diffraction occurs. In FIG. 8, a large symmetric clear viewing cone 16 is achieved: −19° to +19° . FIG. 9 shows the angular distribution of the diffraction light, in which “R”,“G” and “B” respectively denote the red light rays, the green light rays and the blue light rays.

From FIG. 6 and FIG. 8, it can be seen that if a clear viewing cone 16 of −α to +α is desired, the first order diffraction angle of the light should be more negative than the negative clear viewing cone half angle −α.

When the light guide apparatus in FIGS. 6 or 8 is used as a book reader, light of various colors integrates to form white light on the paper 101 due to the light mixing property of paper, as shown in FIG. 10.

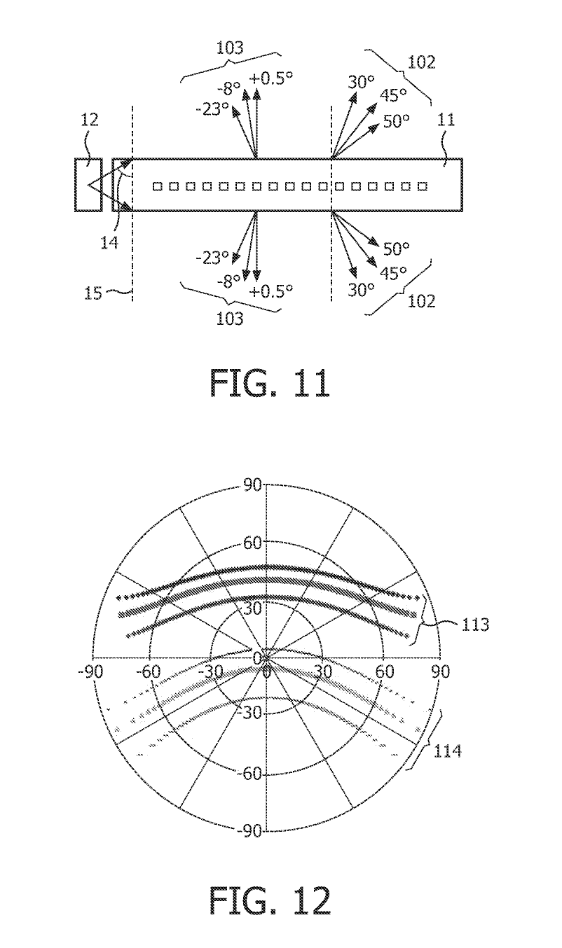

In another embodiment, the pitch of the first diffraction grating 13 is larger than the longest main wavelength of the light emitted by the first light source 12. For example, the first light source 12 is the same as the light source 12 in FIG. 6 and FIG. 8. The pitch of the first diffraction grating 13 is 700 nm. The refractive index of the light guide plate 11 is also 1.5. FIG. 11 shows a schematic view of the optical path of such a light guide apparatus with illumination from one side. In FIG. 11, the incidence angle θᵢ 14 of the light is 67° with the surface normal 15 to the first surface of the light guide 11, and not only the first order diffraction 102 but also the second order diffraction 103 occurs. In the first order diffraction, the red light exits the light guide plate 11 at an angle of +30°, the green light exits the light guide plate 11 at an angle of +45° and the blue light exits the light guide plate 11 at an angle of +50°. In the second order diffraction, the red light exits the light guide plate 11 at an angle of −23°, the green light exits the light guide plate 11 at an angle of −8° and the blue light exits the light guide plate 11 at an angle of +0.5°. FIG. 12 shows the angular distribution of the first and second order diffraction light in FIG. 11.

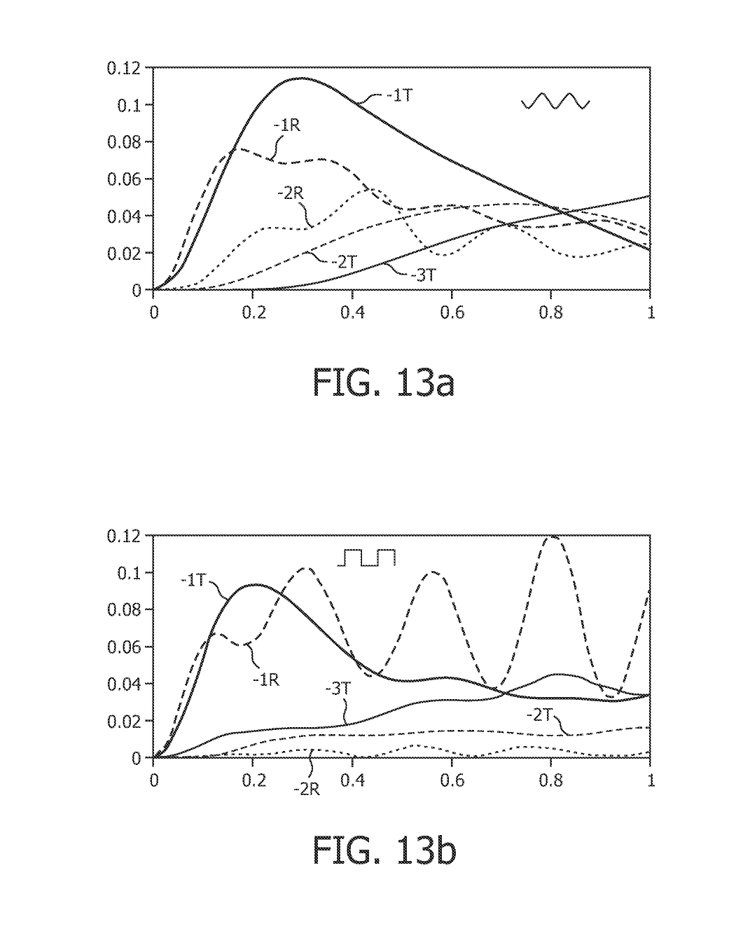

It can be seen from FIG. 11 that the second order diffraction is to be suppressed because it lies in the clear viewing cone, and the second diffraction light will disturb the reader as glare light when he reads the pages under the light guide plate 11. The second order diffraction can be suppressed by a proper design of the grating shape. A sinusoidal grating performs less well than a square shaped one. This is illustrated in FIGS. 13(a) and (b). Note that ambient light that passes along the surface normal will be weakly diffracted. It should also be noted that the shape of the gratings only determines the diffraction efficiency and does not have any impact on the diffraction angles.

FIGS. 13 (a) and (b) respectively show the diffraction efficiencies of sinusoidal and square diffraction gratings with a large pitch of 700 nm. The refractive index of the light guide plate 11 is 1.5. The wavelength of the incidence light is 530 nm and the incidence angle is 67°. The duty cycle of the square diffraction grating is 0.5, “−mT” and “−kR” respectively denote the diffraction efficiency of the m order diffraction and the k order reflection(m=1,2,3; k=1,2). The vertical axis denotes the diffraction efficiency and the horizontal axis denotes the depth (μm) of the first diffraction grating 13. For simplicity, only the diffraction efficiency of the s-polarised light is shown. It is illustrated that for a large-pitch grating of sinusoidal shape the diffraction efficiencies of the second order are not small. However, by using a grating with a square shape, these second order diffractions can be much suppressed. In FIG. 13(b), the diffraction efficiency of the second order diffraction is below 10% of that of the first order diffraction.

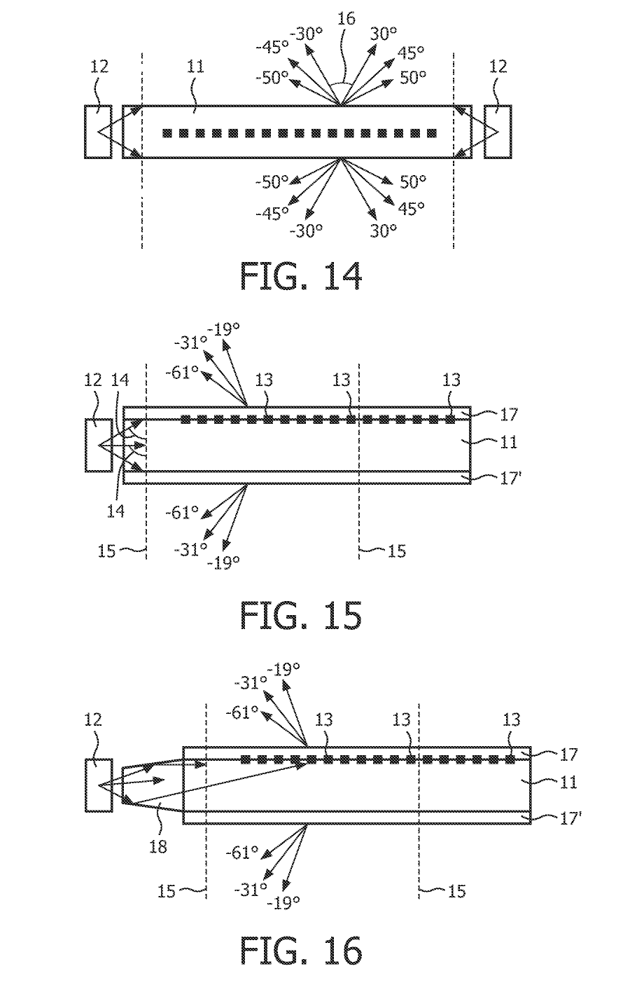

FIG. 14 shows a schematic view of the optical path of a light guide apparatus, based on a square shaped grating with illumination from two sides, in which the second order diffraction grating is well reduced. The parameter of the light guide apparatus in FIG. 14 is the same as that of the light guide apparatus in FIG. 11. A large clear viewing cone 16 of −30° to +30° is achieved.

From FIG. 11 and FIG. 14, it can be seen that if a clear viewing cone 16 of −α to +α is desired, the first order diffraction angle of the light should be more positive than the positive clear viewing cone half angle α.

In an embodiment of the present invention, the light guide plate 11 has two cladding layers 17 and 17′, respectively covering the first and second surface of the light guide plate (11) to prevent scratches. The refractive index of either of the cladding layers 17 and 17′ is lower than the refractive index of the light guide plate 11. It should be understood that the two cladding layers may be made of the same or different materials and may have the same or different refractive indices.

In FIG. 15 such essential features of the scratch resistant configuration are illustrated. The light guide plate 11 is made of a high index polymer, e.g. PolyCarbonate (PC) with n=1.59. A diffraction grating 13 is pressed in one surface of PC and subsequently the light guide plate 11 is coated with two low-index polymer cladding layers 17 and 17′, e.g. silicone with n=1.4. At the interface of PC and silicone, TIR (Total Internal Reflection) will take place for incidence angles larger than arcsin(1.4/1.59)=61.7°. This means that the angles at the input facet have to be restricted to smaller than or equal to 90-61.7=28.3° in PC corresponding to 48.9° in air.

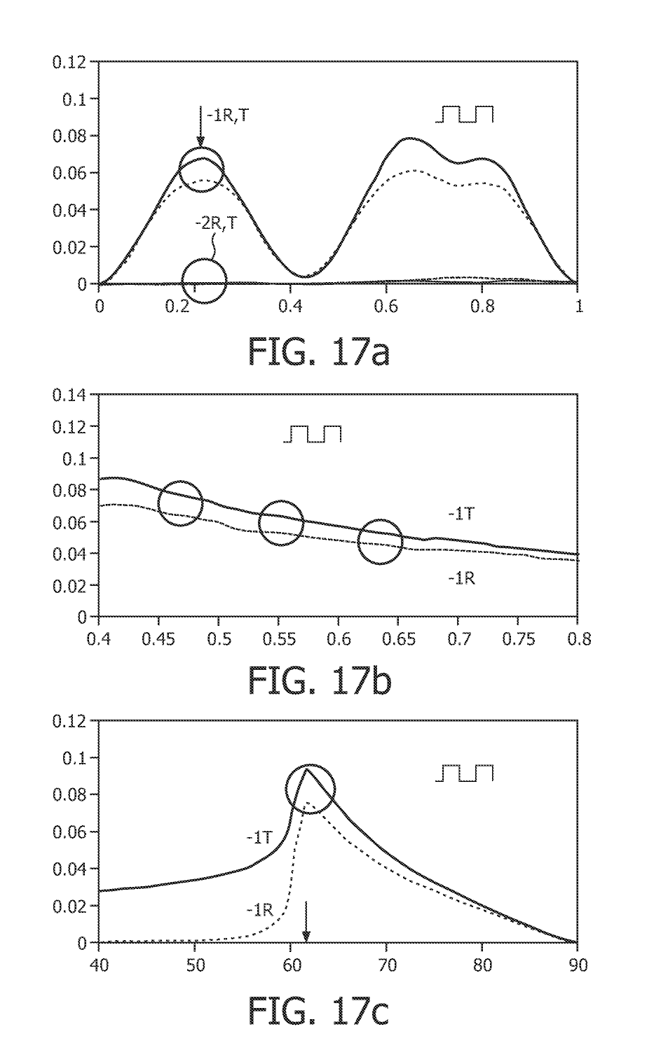

To improve the efficiency of the input light, the light guide apparatus has a tapered collimator 18 between the first light source 12 and the light guide plate 11 for preventing the light from entering the cladding layers 17 and 17′ directly, as shown in FIG. 16. With the simple tapered collimator 18 section, the light will never enter the cladding layers 17 or 17′ directly from the first light source 12, it will only pass through to the light guide plate 11 directly. The pitch of the first diffraction grating 13 can be chosen as small as in FIG. 6 or as large as in FIG. 11. For the latter case, having a large pitch as shown in FIG. 11, the second order diffraction is suppressed even better than in the unclad case as shown in FIG. 14. This is illustrated in FIGS. 17 (a), (b) and (c).

FIGS. 17 (a), (b) and (c) show the diffraction efficiency of a square grating 13 with a large pitch of 700 nm. For simplicity, only diffraction efficiency of the s-polarised light is shown. The vertical axis of FIGS. 17(a), (b) and (c) denotes the diffraction efficiency, the horizontal axis of FIGS. 17(a), (b) and (c) respectively denotes the depth (μm) of the diffraction grating 13, the wavelength (μm) of the incidence light and the diffraction angle (degree). The refractive index of the light guide plate 11 and the cladding layers 17 are respectively 1.59 and 1.4. The wavelength of the incidence light is 530 nm and the incidence angle is 67°. The duty cycle of the square diffraction grating is 0.5, “−mT”, and “−kR”, respectively, denote the m order diffraction and the k order reflection(m=1,2; k=1,2). It can be seen that cladding a square grating of n=1.59 with two cladding layers of n=1.4 reduces the second order diffraction even more. This is very favorable for the first diffraction grating with a large pitch.

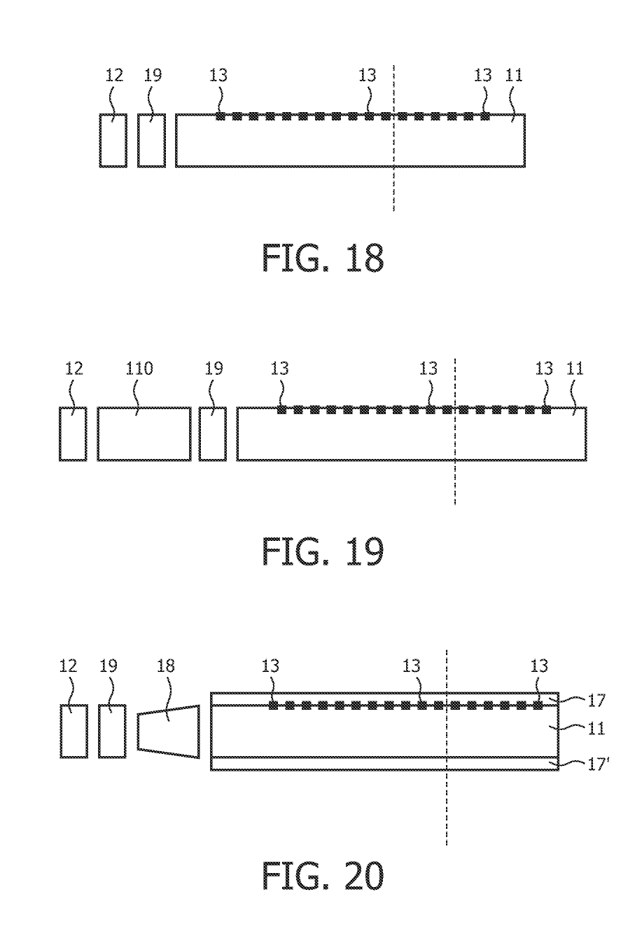

In an embodiment of the present invention, the light guide apparatus has a diffuser 19 between the first light source 12 and the light guide plate 11 as shown in FIG. 18. The diffuser 19 is used to divert/mix the direction of the light before it enters the light guide plate 11 comprising the first diffraction grating 13, causing the light leaving the diffuser 19 to be as homogeneous as light from a “surface/strip” light source instead of the “point” light source 12 such as initial LEDs. Otherwise, a light strip, extending in the direction from light source 12 to the viewer's eyes on the light guide plate 11 surface, will be observed when the light guide plate 11 is viewed at a different angle. Without the diffuser 19 a streaky LED pattern is visible. The diffuser 19 makes the streaks disappear and the light becomes more uniform.

Alternatively, there is a mixing light guide 110 between the first light source 12 and the diffuser 19 to guide the light into the diffuser 19, as shown in FIG. 19.

FIG. 20 shows a schematic view of a tapered collimator 18 and a diffuser 19 which co-exist. The light enters the diffuser 19 first and then enters the tapered collimator 18.

It should be understood by those skilled in the art that in the case of two light sources as shown in FIG. 8, there is a diffuser 19 and/or a tapered collimator 18 between each light source 12 and the light guide plate 11.

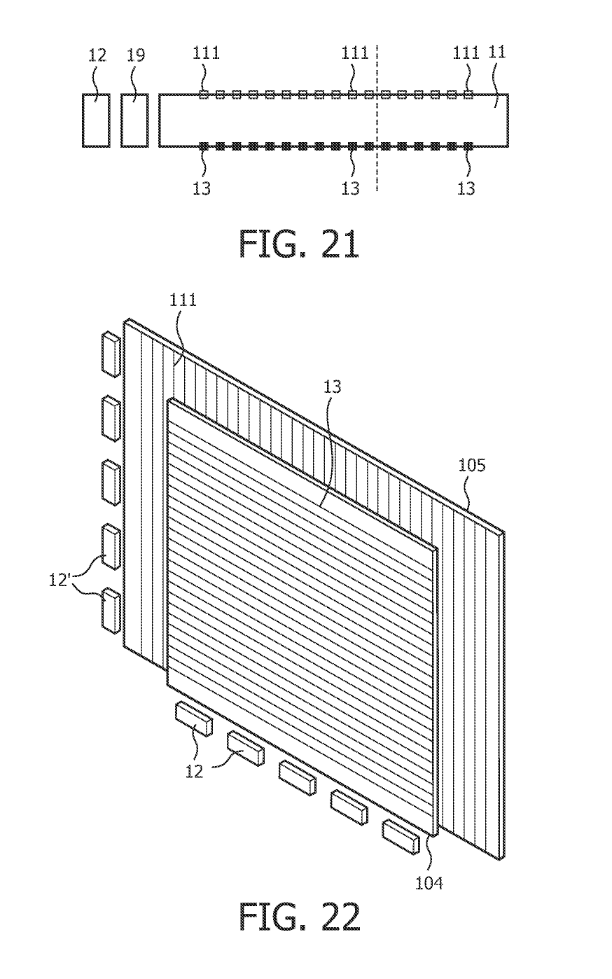

According to another embodiment of the present invention, in addition to the first diffraction grating 13, the light guide apparatus comprises a second diffraction grating 111, which crossesor is parallel to the first diffraction grating 13, and which is located on a second surface, opposite the first surface, of or inside the light guide plate 11. FIG. 21 shows such a light guide apparatus with two parallel diffraction gratings 13 and 111. Via two parallel diffraction gratings, the intensity of the diffraction light is doubled.

According to an embodiment of the present invention, a large clear viewing cone and more light are achieved through the two diffraction gratings having different pitches. The wavelength of the light injected into the first diffraction grating 13 having a small pitch is shorter than the wavelength of the light injected into the second diffraction grating 111 having a relatively large pitch. And the light injected into the first diffraction grating 13 does not interact with the second grating 111. This can be prevented in two ways:
(1) two crossed diffraction gratings on a single light guide plate 11, respectively, on the top surface and the bottom surface, i.e. the first and the second surface;
(2) two separate light guides, not in contact with each other , each having a diffraction grating. The two gratings can be parallel or crossed.

FIG. 22 shows a schematic view of the two diffraction gratings 13 and 111, respectively, located on the two surfaces 104 and 105 of a light guide apparatus. The two diffraction gratings are perpendicular to each other. The first diffraction grating 13 has a pitch of 240 nm. Blue and green light is injected into the first diffraction grating 13. The second diffraction grating 111 has a pitch of 275 nm. Red light is injected into the second diffraction grating 111.

As compared to the light guide apparatus comprising only the first diffraction grating 13, the light guide apparatus in FIG. 22 achieves red light which is not diffracted by the light guide apparatus comprising only the first diffraction grating 13. As compared to the light guide apparatus comprising only the second diffraction grating 111, the light guide apparatus in FIG. 22 achieves a large clear viewing cone which is larger than the clear viewing cone achieved by the light guide apparatus comprising only the second diffraction grating 111.

The embodiments of the present invention have been described above. And all alternative technical features can be combined, such as the second light source 12 and the cladding layers 17 and 17′, the second diffraction grating 111 and the cladding layers 17 and 17′, the second diffraction grating 111 and the diffuser 19 etc.

It should be understood that the optical paths of the Figures are only illustrative and not all light rays are shown in the Figures, for simplicity.

Numerous alterations and modifications of the structure disclosed herein will present themselves to those skilled in the art. However, it is to be understood that the above described embodiment is for the purpose of illustration only and not to be construed as a limitation of the invention. All such modifications which do not depart from the spirit of the invention are intended to be included within the scope of the appended claims. In the claims, any reference signs placed between parentheses shall not be construed as limiting the claim. The verb “to comprise” and its conjugations does not exclude the presence of elements or steps not listed in a claim or in the description. The word “a” or “an” preceding an element does not exclude the presence of a plurality of such elements. The usage of the words first, second and third, et cetera, does not indicate any ordering. These words are to be interpreted as names.

1. A light guide apparatus, comprising:
a light guide plate having a first surface and a second surface opposite thereto and comprising
a first diffraction grating;
a first light source coupled to a first side of the light guide plate;
wherein the first diffraction grating is configured to extract the light generated by the first light source from the first surface and the second surface.

2. The apparatus according to claim 1, wherein the pitch of said first diffraction grating is smaller than the shortest main wavelength of said light.

3. The apparatus according to claim 2, wherein the first order diffraction angle of said light is more negative than the desired negative clear viewing cone half angle.

4. The apparatus according to claim 1, wherein the pitch of said first diffraction grating is larger than the longest main wavelength of said light.

5. The apparatus according to claim 4, wherein said diffraction grating is square shaped to suppress the second order diffraction of said light.

6. The apparatus according to claim 4, wherein the first order diffraction angle of said light is more positive than the desired positive clear viewing cone half angle.

7. The apparatus according to claim 1, wherein said light guide plate has two cladding layers covering, respectively, said first surface and said second surface of the light guide plate, and the refractive index of either of the cladding layers is lower than the refractive index of said light guide plate.

8. The apparatus according to claim 7, further comprising a tapered collimator between said first light source and said light guide plate for preventing the light from entering the cladding layers directly.

9. The apparatus according to claim 1, wherein said light guide apparatus has a diffuser between said first light source and said light guide plate.

10. The apparatus according to claim 9, wherein said light guide apparatus has a mixing light guide between said first light source and said diffuser.

11. The apparatus according to claim 1, further comprising a second light source, coupled to a second side, opposite to the first side, of the light guide plate.

12. The apparatus according to claim 1, further comprising a second diffraction grating, crossed or parallel to said first diffraction grating, and located on the second surface of or inside said light guide plate.

13. The apparatus according to claim 12, wherein the first diffraction grating is crossed with respect to the second diffraction grating and has a smaller pitch than the second diffraction grating, and the light injected into the first diffraction grating does not interact with the second diffraction grating and has a shorter wavelength than the light injected into the second diffraction grating.

14. A light guide device comprising a first apparatus as claimed in claim 1 and a second apparatus, wherein the first diffraction grating of the first apparatus has a smaller pitch than the first diffraction grating of the second apparatus, the light injected into the first diffraction grating of the first apparatus has a shorter wavelength than the light injected into the first diffraction grating of the second apparatus, and the light guide plate of the first apparatus is not in contact with the light guide plate of the second apparatus.

15. The apparatus according to claim 1, wherein the first diffraction grating is disposed on the first surface of the light guide plate.

16. The apparatus according to claim 1, wherein the first diffraction grating is disposed within the light guide plate.
